(19) United States
(12) Patent Application Publication
(10) Pub. No.: US 2016/0004235 A1
(43) Pub. Date: Jan. 7, 2016

(54) Appliance Control System and Method

(71) Applicant: SENSELOGIX LIMITED, Manchester (GB)

(72) Inventors: Jonathan Luke, Colwyn Bay (GB); Stavros Antoniou, Llandudno Junction (GB)

(73) Assignee: SENSELOGIX LIMITED, Sale (GB)

(21) Appl. No.: 14/768,195

(22) PCT Filed: Feb. 17, 2014
(86) PCT No.: PCT/EP2014/053005

§ 371 Date: Aug. 14, 2015

(30) Foreign Application Priority Data
Feb. 15, 2013 (GB) 1302643.0

(51) Int. Cl. G05B 15/02; H04L 12/28

(52) U.S. Cl. CPC G05B 15/02; H04L 12/2829

(57) ABSTRACT

An appliance control system (1) comprising: a plurality of nodes (A, B, C), each said node being operable to control an electrical socket (5, 7, 9) and to generate operating data concerning the operation of an appliance (11, 13, 15) plugged into a socket associated with the node; a plurality of appliances (11, 13, 15), each said appliance being plugable into a said socket for the supply of electrical power from the socket to the appliance; a plurality of sensors (17, 19, 21), wherein each said sensor is operable to generate consequential data concerning an appliance of said plurality of appliances to which the sensor is related; and a system controller (3) in communication with said nodes for the receipt of operating data and with said sensors for the receipt of consequential data, said system controller (3) being operable to implement an energy policy by signalling one or more of said nodes to turn the associated electrical socket on or off, said system controller (3) being further operable to establish for each node/sensor association an operating profile and a consequential profile from said operating and consequential data respectively.

### FIELD

This invention relates to appliance control systems, to methods for controlling appliances, and to system controllers for such systems. In one envisaged application, the teachings of the invention may be applied to the control of heat transfer appliances, such as—for example—chiller cabinets (also known as chillers), freezers and the like.

### BACKGROUND

In order to reduce the energy consumption of refrigeration appliances (such as freezers and chiller cabinets, for example) within a store it has previously been proposed to provide a control system which monitors the temperature of the appliance, and extends the normal “off period” of the appliance's on-off compressor cycle whilst the monitored temperature of the appliance remains below a predetermined value.

For example, in one previously proposed arrangement the “off period” is extended by removing the power from the socket into which the freezer is plugged while the compressor is off and the temperature is below a given value. Power is returned to the socket only once the freezer temperature increases to a predetermined temperature read from a temperature sensor which is associated with (for example permanently attached to) the freezer.

FIG. 1 is a schematic representation of a previously proposed control system 1 that has a plurality of nodes “A”, “B” and “C” and a system controller 2. Each node communicates with the controller 2 and is capable of controlling a fixed socket outlet 5, 7, 9 with which the node is associated on the basis of instructions received from the controller 3. The nodes are also capable of monitoring operating parameters (such as power drawn, for example) of an appliance plugged into a socket associated with the node, and receiving data from other sensors (such as a wireless temperature sensor, for example). Such nodes are known in the art, and one illustrative example is the SenseLogix Energy Node, Part no:ELENMC162NSL available from SenseLogix Limited, 7 Mollington Grange, Parkgate Road, Chester, CH1 6NP, UK. Wireless temperature sensors of the type mentioned above are known in the art. An illustrative example is the 4-NOKS ZB-Connect, Wireless Temperature Sensor, Part No: available from 4-NOKS S.R.L, Via per Sacile, 158, 31018 Francenigo di Gaiarine (TV), Italy.

In this illustrative example, a freezer 11, 13, 15 is plugged into each of the socket outlets, and each of these freezers has a temperature sensor 17, 19, 21 associated with it. The temperature sensors 17, 19, 21 are each able to communicate with the node that controls the socket into which the freezer associated with the sensor is plugged.

In a typical store, it is usual for product to be moved around the store at particular times of year. For example, in warmer months a store may decide to move frozen goods such as ice creams towards the front of the store to improve the likelihood of customers purchasing those ice creams. In order to avoid unloading and re-loading freezers, moving product is usually achieved by physically moving the freezers containing the product around the store, and to facilitate this it is normal for the above mentioned temperature sensors to communicate wirelessly with their associated node so that the number of cables that need to be unplugged during the move can be reduced.

Unfortunately, if a given node of the system is controlling the power to a fixed socket into which a given freezer (for example) is plugged, and that freezer (with its associated temperature sensor) is moved to another node at a different location in the store, it is not currently possible to automatically spot and record the move between nodes. As a result, a given node can inadvertently end up controlling a freezer other than the particular freezer that is plugged into the fixed socket associated with that node, thereby resulting in the potential for that freezer to be accidentally defrosted.

This situation is illustrated schematically in FIG. 2 of the drawings. In this instance, freezer 11 and freezer 15 have swapped positions within a store, and the temperature sensor 17 associated with freezer 15 is still communicating with node “C”. However, node “C” is now controlling the socket 9 into which freezer 11 is plugged instead of the socket into which freezer 15 is plugged. Thus if it is determined (from temperature data obtained via the wireless link to temperature sensor 21) that it is reasonable to extend the off cycle of the compressor in freezer 15, the node will in fact control socket 9 and turn off freezer 11. If freezer 11 should be opened regularly, then there is a real risk of the freezer, and the frozen goods inside the freezer, defrosting.

One way to address this problem would be to reconfigure the control system each time the freezers are moved around, but such a solution could be very time consuming (and hence expensive) in a typical retail establishment that has many freezers throughout the store.

With the above in mind, the present invention seeks to mitigate the problems outlined above, or at least to provide a useful alternative to existing arrangements.

### SUMMARY

To this end, a presently preferred implementation of the teachings of the present invention provides an appliance control system comprising: a plurality of nodes, each said node being operable to control an electrical socket and to generate operating data concerning the operation of an appliance plugged into a socket associated with the node; a plurality of appliances, each said appliance being plugable into a said socket for the supply of electrical power from the socket to the appliance; a plurality of sensors, wherein each said sensor is operable to generate consequential data concerning an appliance of said plurality of appliances to which the sensor is related; and a system controller in communication with said nodes for the receipt of operating data and with said sensors for the receipt of consequential data, said system controller being operable to implement an energy policy by signalling one or more of said nodes to turn the associated electrical socket on or off, said system controller being further operable to establish for each node/sensor association an operating profile and a consequential profile from said operating and consequential data respectively.

In one implementation said system controller is operable to confirm a said association by comparing said operating and consequential profiles.

In one implementation said appliance controller confirms a node/sensor association if the consequential profile reflects a change in consequential data that occurs as a result of a change in operational data reflected in said operational profile.

In one arrangement said appliance controller is configured to deny and disassociate a node/sensor association if the consequential profile does not reflect a change in consequential data that occurs as a result of a change in operational data reflected in said operational profile. In a preferred implementation, in the event that an association is denied and a node and sensor are disassociated, the node is instructed by the system controller to turn the socket on. This is a failsafe measure that avoids inadvertently turning off the wrong appliance.

Preferably said appliance controller is configured to signal a disassociated node to power on the socket associated with said node.

In one envisaged implementation said appliance controller is configured to identify nodes and sensors that are not associated, and to associate nodes and sensors if the consequential profile for a said sensor reflects a change in consequential data that occurs as a result of a change in operational data reflected in said operational profile for a said node.

Preferably said system controller is configured to repeatedly compare operational and consequential profiles to thereby automatically associate and disassociate node/sensor pairs.

The system controller may be operable to signal a said node of said plurality to power off a connected appliance to confirm an association between the powered-off node and a sensor.

The appliances may comprise heat transfer appliances, for example freezer or chiller cabinets. The sensors may comprise temperature sensors. Each said sensor may be configured to determine the temperature inside a said heat transfer appliance.

Preferably said operational data comprises data concerning the power drawn by an appliance plugged into a socket.

The sensors may comprise wireless sensors. The sensors may be configured to communicate wirelessly with the nodes. The sensors may communicate with said system controller via said nodes. The sensors may communicate wirelessly with said system controller.

In one arrangement, the nodes are each built into a socket with which they are associated. In this implementation the nodes could communicate with the system controller using Power Line Communications protocols.

Another aspect of the invention relates to a system controller for use with the system according to any preceding claim, the controller comprising: an interface for communicating with said nodes and said sensors for the receipt of operational and consequential data; a parameter profiling module for generating operating parameter profiles from said operating data and consequential parameter profiles from said consequential data; and a comparison module for comparing operating parameter profiles and consequential parameter profiles for node/sensor associations.

Preferably said comparison module is configured to confirm a node/sensor association if the consequential profile for the sensor of said association reflects a change in consequential data that occurs as a result of a change in operational data reflected in said operational profile for the node of said association.

Preferably said appliance controller is configured to deny and disassociate a node/sensor association if the consequential profile does not reflect a change in consequential data that occurs as a result of a change in operational data reflected in said operational profile.

Another aspect of the invention relates to a method of controlling appliances, the method comprising: determining an operating profile for a node of a node/sensor pair, the operating profile reflecting changes in operating data concerning an appliance associated with the node; determining a consequential profile for a sensor of said node/sensor pair, the consequential profile reflecting changes in consequential data concerning a sensor associated with the node; and periodically comparing the operating and consequential profiles of a node/sensor association to determine whether said association is valid.

A further aspect of the invention relates to a control system that is configured to monitor the power profile of an appliance, to monitor a parameter of an appliance (for example, a physical parameter, such as temperature), and periodically to compare the power profile with the appliance parameter. In one particularly preferred implementation, the teachings of the invention provide a system that monitors the energy consumption and temperatures of multiple freezers and/or chillers and continually compares the temperature profile of the freezer with the power profile measured by the node. A method implemented by such a control system is also claimed.

By virtue of the foregoing arrangements, it is possible to spot when the freezer's temperature changes in an unexpected way, breaking the association between the node and freezer.

The described system can then look at the resulting “disassociated” nodes and freezers and spot the correct freezer's temperate profile allowing is to automatically re-associate the correct freezer-node combination.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a schematic representation of a control system and a plurality of appliances;

FIG. 2 is a schematic representation of the system shown in FIG. 1 after some of the appliances have been moved;

FIG. 3 is a chart showing changes in an operating parameter profile and a consequential parameter profile for an appliance, in this instance a freezer;

FIG. 4 is a chart showing changes in an operating parameter profile for a first appliance and a consequential parameter profile for a different appliance;

FIG. 5 is an illustrative representation of a system controller that is capable of implementing the teachings of the present invention;

FIG. 6 is a schematic representation of the software modules executed by the system controller; and

FIG. 7 is a flow diagram illustrating the process of node and sensor association and disassociation.

### DETAILED DESCRIPTION

Preferred embodiments of the present invention will be described below in the context of the management of heat transfer appliances, in particular freezers, in a store. However, it will be apparent to persons of ordinary skill in the art that the teachings of the present invention are more widely applicable to the control of other types of appliance, and/or in other types of establishments. As such, the following detailed description should be read as being merely illustrative of the teachings of the present invention.

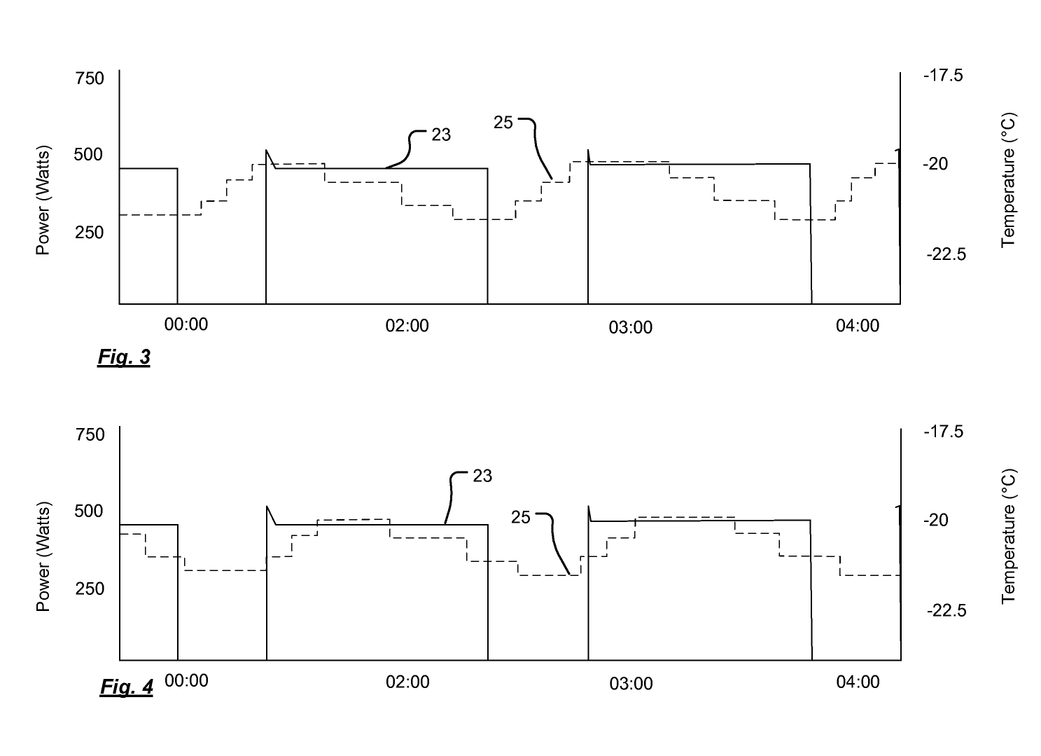

The general concepts underpinning the teachings of the present invention will now be described with reference to FIG. 3 of the accompanying drawings. As mentioned above, FIG. 3 is a chart that shows how an operating parameter profile 23 and a consequential parameter profile 25 for an appliance change over time. In this particular example, the appliance is a freezer, the operating parameter is the power drawn by a freezer (which indicates whether the compressor of the freezer is operating), and the consequential parameter is the temperature inside a freezer (as measured by a wireless temperature sensor attached to the freezer). It will be appreciated however that the term “operating parameter” is merely intended to refer to any parameter which indicates that an appliance is operating, and the term “consequential parameter” is merely intended to refer to any parameter that changes in accordance with whether or not the appliance is operating.

As shown in FIG. 3, the temperature inside the freezer fluctuates between about −21.5 and about −20 degrees centigrade, and the power drawn by the freezer fluctuates between about 0 Watts and about 450 Watts. The temperature inside the freezer decreases from a peak whilst the compressor of the freezer is operating and the power drawn by the freezer is at a peak. Conversely, once the compressor is switched off, the power drawn by the freezer drops to about zero and the temperature within the freezer begins to rise back up towards the aforementioned peak. Once the peak is reached the compressor is switched on again, and the temperature of the freezer begins to drop once more.

As shown in FIG. 3, the power profile and temperature profile are directly responsive to one another, in that a change in one causes a change (in this case an inverse change) in the other. In other words, changes in the temperature profile are a direct consequence of changes in the power profile. As such it is fair to assume that the temperature profile depicted in FIG. 3 is representative of temperature variations inside the particular freezer that the depicted power profile relates to—or in other words that the wireless temperature sensor and the node are properly associated with one another.

In FIG. 4, in contrast, the temperature profile starts to rise when the power profile peaks (when one would expect it to fall), and starts to fall when the power profile falls to zero (when one would expect it to rise). Since the power and temperature profiles are not responsive to one another and changes in the one are not a consequence of changes in the other, it follows that the temperature and power profiles depicted in FIG. 4 are not properly associated with one another and hence that the node is monitoring a temperature sensor that is monitoring a freezer other than the one that the node is controlling.

On the basis of the foregoing it will be apparent to persons of ordinary skill in the art that by comparing an operating profile (in this particular example, a power profile) and a consequential profile (in this instance, a temperature profile) it is possible to devise a control system that can automatically pair appliances and nodes, and thereby automatically reconfigure itself when appliances are moved from one node to another.

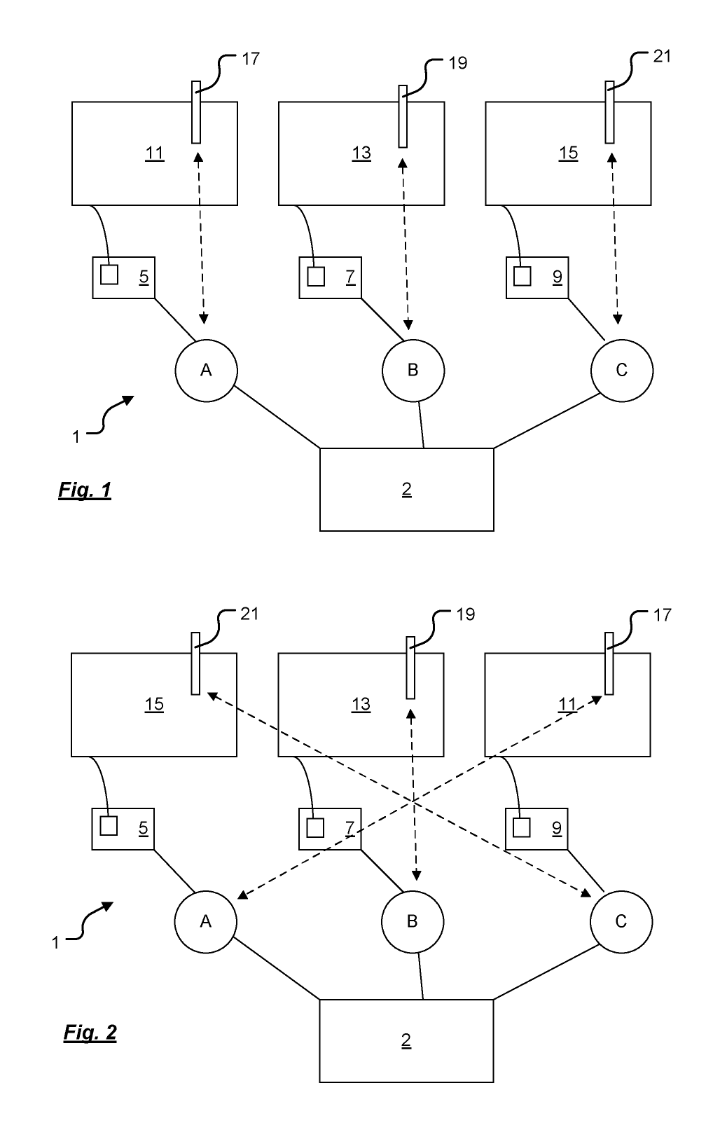

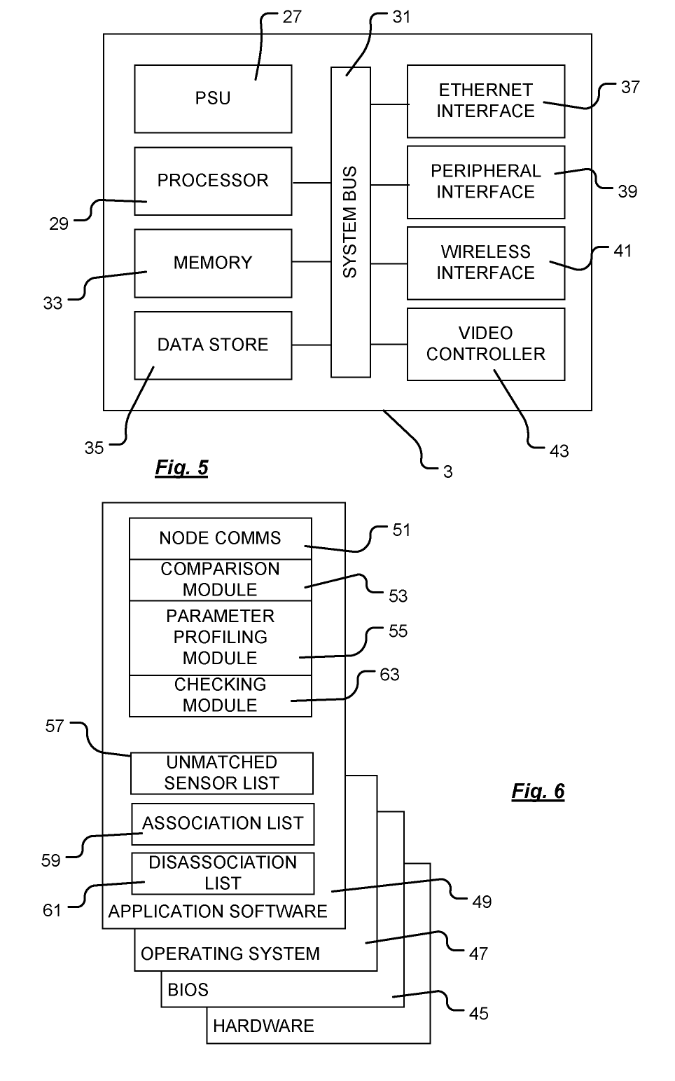

Referring now to FIG. 5 of the accompanying drawings, there is depicted a schematic representation of a system controller 3 that is capable of implementing the teachings of the present invention. An advantage of one implementation of the teachings of the present invention is that the invention can be implemented simply by replacing or upgrading the system controller of a system of the type shown in FIG. 1 or 2. Since the other elements of the control system with which the system controller is used are as depicted in FIGS. 1 and 2, for brevity they will not further be described herein.

The depiction of the system controller 3 shown in FIG. 5 is merely illustrative and shows the various components of controller in block component format. In particular it should be noted that the block diagram of the controller is not inclusive of all components of the controller, but is merely representative of many example components.

The system controller 3 comprises a power supply unit 27 that is configured to draw power from a mains power supply and regulate the supply of power to the remaining components of the controller. The controller includes a processor 29 that is coupled to a system bus 31 by means of which signals can be sent between the processor and the other components of the controller. The controller 3 further comprises read only memory (ROM) and/or random access memory (RAM) 33 that provides a processing environment in which the processor 29 can execute computer programs.

The controller 3 also includes a data store 35 for the storage of computer programs for execution by the processor. The data store may comprise one or more hard disk drives (HDDs), and in a particularly preferred embodiment comprises a plurality of hard disk drives configured as a RAID (Redundant Array of Inexpensive Disks) to provide redundancy in the event that one or more drives of the array should fail.

In this illustrative embodiment, the system bus 31 is coupled to an Ethernet interface 37, a wireless interface 41, a peripheral interface 39 and a video controller 43. The Ethernet interface is configured to provide a network connection between the controller 3 and other components of the control system 1—such as Ethernet enabled nodes. The wireless interface is configured to enable the system controller to interface with a wireless network for the receipt and transmission of signals from and to the wireless network. The wireless interface could be incorporated, as illustrated, into the controller or in another embodiment the wireless interface could comprise stand-alone wireless transceiver equipment coupled to the system controller, for example, by an Ethernet connection.

The peripheral interface 39 is configured to enable user interface devices, such as a keyboard and/or pointing device (such as a mouse or trackball), and ancillary equipment such as one or more printers to be connected to the control system for use therewith. The peripheral interface could include RS232 connectors, USB connectors, PS2 connectors or any other type of connector. The video controller 43 provides an interface that enables a display, not shown, to be coupled to the controller 3, and functions in response to signals from the processor to generate images for display on the display.

Much of the functionality to be described below is implemented in software, but it will be appreciated by persons skilled in the art that some or all of this functionality could alternatively be implemented in hardware (for example by means of one or more application specific integrated circuits (ASICs)) or by means of a combination of hardware and software. As such, the scope of the present invention should not be interpreted as being limited only to being implemented in software.

With the above proviso in mind, reference will now be made to FIG. 6 of the accompanying drawings. In an envisaged implementation, the controller processor 29 and memory 33 cooperate to establish a BIOS (Basic Input/Output System) 45 that functions as an interface between the functional hardware components of the system controller (shown in FIG. 5) and the software executed by the controller. The processor then loads from memory 33 and/or data store 35 an operating system 47 which provides an environment in which application software 49 (implementing some or all of the functionality described below) can run. In accordance with an illustrative implementation of the teachings of the present invention, all or part of this functionality is provided by a node communications module 51, a comparison module 53, a parameter profiling module 55 and a checking module 63, the functions of each of which will be described below. The processor 29 also co-operates with the memory 33 and/or data store 35 to maintain a list 59 of nodes that are each a candidate for association with a sensor (in this implementation, a temperature sensor), a list 57 of unmatched sensors and a list 61 of nodes that are each a candidate for disassociation from a sensor.

The node communications module 51 is configured, as the name suggests, to communicate with nodes of the system and instruct those nodes—in accordance with an energy usage policy established by the operator of the system—to turn the sockets with which they are associated on and off. One aim of this arrangement might be, where possible, to extend the off cycle of the appliances normal on/off compressor cycle so as to reduce energy consumption of the system as a whole.

The comparison module 53 is configured to compare operating parameter profiles with consequential parameter profiles to determine whether those profiles relate to the same or different appliances, to disassociate nodes and (in this example) sensors that are not related to the same appliance, and to associate nodes and (in this example) sensors that appear to be related to the same appliance.

The parameter profiling module 55 is operable to receive data from the nodes and establish for each node that is associated with a sensor a profile for the operating parameter and the consequential parameter (in this particular example the power drawn by the appliance and the temperature inside the appliance).

The checking module 63 is configured to check for un-matched sensors in the unmatched sensor list, and in conjunction with the parameter profiling module to check for appliances with an operating parameter profile that indicates that the appliance is in a low power operating mode.

The unmatched sensor list, again as the name suggests, is a list of unmatched sensors—in this instance wireless temperature sensors. The association list comprises a list of nodes that are candidates for association with a sensor, and the disassociation list comprises a list of nodes that are candidates for disassociation with a sensor.

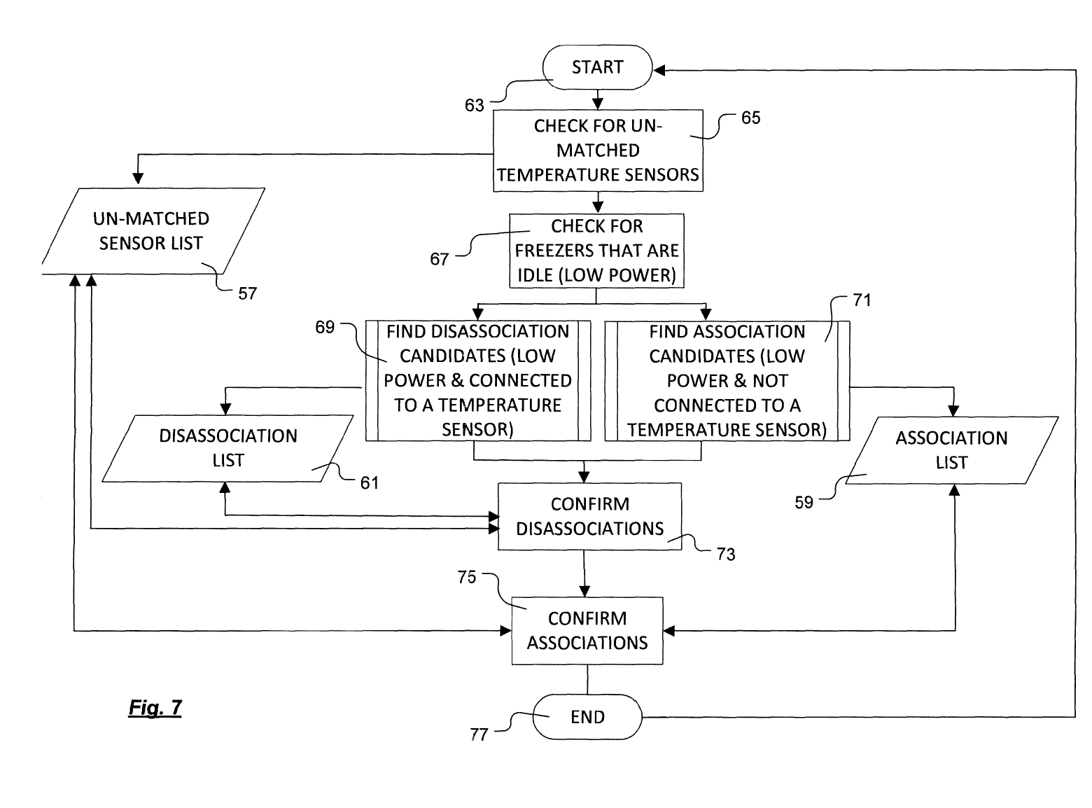

Referring now to FIG. 7, in a first step 65 the checking module consults the unmatched sensor list 57 to determine whether there are any un-matched sensors. Next, in step 67 the checking module 63 cooperates with the parameter profiling module 55 to identify appliances that are in a low power mode (for example a mode where the compressor of the appliance, in the case of a heat transfer appliance, is not operating).

In step 69 the checking module identifies those nodes where, in this particular example, the operating parameter indicates that the connected appliance is in a low power mode and the node is associated with a sensor (in this example, a temperature sensor), and adds any nodes identified in step 69 to the disassociation list 61.

In step 71 the checking module 63 identifies those nodes where the operating parameter indicates that the connected appliance is in a low power mode and the node is not associated with a sensor (in this example a temperature sensor), and adds any nodes identified in step 71 to the association list 59.

Next in step 73 the comparison module 53 compares the operating parameter profile (determined by the parameter profiling module 55) for the nodes listed in the disassociation list 61 to the corresponding consequential parameter profile and determines whether those nodes should or should not be disassociated with their corresponding sensor. Where a determination is made that a given node should be disassociated from the corresponding sensor, the sensor is added to the un-matched sensor list 57 and the node is left in the “on” state to guard against accidental defrosting of the appliance connected to it.

Next in step 75 the comparison module 53 compares the operating parameter profile (determined by the parameter profiling module 55) for the nodes listed in the association list 59 with the consequential parameter profiles for the unmatched sensors listed in the unmatched sensor list 57, and associates nodes with un-matched sensors where the operating parameter profile and the consequential parameter profile are determined to be related.

New and existing associations will then continue until the next compressor off-cycle when the above described process recommences.

In a modification of the foregoing, the comparison module may be configured to implement a positive association check where power is deliberately removed from appliance whilst all other appliances are left operating. If the temperature sensor associated with the appliance from which power has been withdrawn starts to rise, then the association has been determined to be valid.

As mentioned above, the teachings of the present invention provide a mechanism whereby nodes and sensors can be automatically associated and disassociated from one another, thereby enabling the system as a whole to be automatically reconfigured to account for any appliances that have been moved from one node to another.

It will be appreciated that whilst various aspects and embodiments of the present invention have heretofore been described, the scope of the present invention is not limited to the particular arrangements set out herein and instead extends to encompass all arrangements, and modifications and alterations thereto, which fall within the spirit and scope of the appended claims. For example, whilst the teachings of the present invention have been described above in the context of a plurality of software modules, it will be apparent to persons of ordinary skill in the art that the teachings of the present invention could instead be implemented in hardware, for example by means of one or more application specific integrated circuits, or indeed by a mix of hardware and software. Thus, the teachings of the present invention should not be interpreted as being limited solely to software.

As mentioned above, the teachings of the present invention contemplate the use of different operating parameter and consequential parameter profiles to those set out above. Accordingly, the scope of the present invention should not be read as being limited only to the use of power and temperature profiles. For example, the operating profile may be established on the basis of current or voltage drawn by the appliances.

In the preferred arrangement, the nodes are configured to communicate wirelessly with temperature sensors and relay temperature data to the system controller. Whilst this arrangement is preferred, it will be appreciated that the system controller could additionally or alternatively directly communicate with some or all of the temperature sensors in the system. For example, in one envisaged implementation the the temperature sensors may communicate with a separate wireless receiver “hub” which the controller interrogates at regular intervals via a wired Ethernet or Wireless netwok. Similarly, whilst in the arrangements described above the nodes are depicted as being separate from and coupled to the sockets, it is conceivable for some or all of the nodes to be built into the sockets that they are controlling. In such an arrangement, the system controller could be configured to communicate with the nodes using so-called “Power Line Communications” (PLC) protocols, thereby reducing the amount of wiring required to implement the system.

In an envisaged modification of the arrangement described herein, the system controller may be configured to signal nodes to turn off their associated socket (and hence turn off the appliances plugged into those sockets) when the temperature of the appliance reaches a predetermined minimum, following which the system controller may look for associations as described above.

It should also be noted that whilst the accompanying claims set out particular combinations of features described herein, the scope of the present invention is not limited to the particular combinations hereafter claimed, but instead extends to encompass any combination of features herein disclosed.

Finally, it should be noted that any element in a claim that does not explicitly state “means for” performing a specified function, or “steps for” performing a specific functions, is not to be interpreted as a “means” or “step” clause as specified in 35 U.S.C. Sec. 112, par. 6. In particular, the use of “step of” in the claims appended hereto is not intended to invoke the provisions of 35 U.S.C. Sec. 112, par. 6.

1. An appliance control system comprising:
a plurality of nodes, each said node being operable to control an electrical socket and to generate operating data concerning the operation of an appliance plugged into a socket associated with the node;
a plurality of appliances, each said appliance being plugable into a said socket for the supply of electrical power from the socket to the appliance;
a plurality of sensors, wherein each said sensor is operable to generate consequential data concerning an appliance of said plurality of appliances to which the sensor is related; and
a system controller in communication with said nodes for the receipt of operating data and with said sensors for the receipt of consequential data, said system controller being operable to implement an energy policy by signalling one or more of said nodes to turn the associated electrical socket on or off, said system controller being further operable to establish for each node/sensor association an operating profile and a consequential profile from said operating and consequential data respectively.

2. A system according to claim 1, wherein said system controller is operable to confirm a said association by comparing said operating and consequential profiles.

3. A system according to claim 2, wherein said appliance controller confirms a node/sensor association if the consequential profile reflects a change in consequential data that occurs as a result of a change in operational data reflected in said operational profile.

4. A system according to claim 2, wherein said appliance controller is configured to deny and disassociate a node/sensor association if the consequential profile does not reflect a change in consequential data that occurs as a result of a change in operational data reflected in said operational profile.

5. A system according to claim 4, wherein said appliance controller is configured to signal a disassociated node to power on the socket associated with said node.

6. A system according to claim 1, wherein said appliance controller is configured to identify nodes and sensors that are not associated, and to associate nodes and sensors if the consequential profile for a said sensor reflects a change in consequential data that occurs as a result of a change in operational data reflected in said operational profile for a said node.

7. A system according to claim 2, wherein said system controller is configured to repeatedly compare operational and consequential profiles to thereby automatically associate and disassociate node/sensor pairs.

8. A system according to claim 2, wherein said system controller is operable to signal a said node of said plurality to power off a connected appliance to confirm an association between the powered-off node and a sensor.

9. A system according to claim 1, wherein said appliances comprise heat transfer appliances, for example freezer or chiller cabinets.

10. A system according to claim 1, wherein said sensors comprise temperature sensors.

11. A system according to claim 9, wherein each said sensor is configured to determine the temperature inside a said heat transfer appliance.

12. A system according to claim 1, wherein said operational data comprises data concerning the power drawn by an appliance plugged into a socket.

13. A system according to claim 1, wherein said sensors comprise wireless sensors.

14. A system according to claim 13, wherein said sensors are configured to communicate wirelessly with the nodes and/or said system controller.

15. A system according to claim 14, wherein said sensors communicate with said system controller via said nodes.

16. (canceled)

17. A system according to claim 1, wherein said nodes are each built into a socket with which they are associated.

18. A system controller for use with the system according to claim 1, the controller comprising:
an interface for communicating with said nodes and said sensors for the receipt of operational and consequential data;
a parameter profiling module for generating operating parameter profiles from said operating data and consequential parameter profiles from said consequential data; and
a comparison module for comparing operating parameter profiles and consequential parameter profiles for node/sensor associations.

19. A controller according to claim 18, wherein said comparison module is configured to confirms a node/sensor association if the consequential profile for the sensor of said association reflects a change in consequential data that occurs as a result of a change in operational data reflected in said operational profile for the node of said association.

20. A controller according to claim 18, wherein said appliance controller is configured to deny and disassociate a node/sensor association if the consequential profile does not reflect a change in consequential data that occurs as a result of a change in operational data reflected in said operational profile.

21. A method of controlling appliances, the method comprising:
determining an operating profile for a node of a node/sensor pair, the operating profile reflecting changes in operating data concerning an appliance associated with the node;
determining a consequential profile for a sensor of said node/sensor pair, the consequential profile reflecting changes in consequential data concerning a sensor associated with the node; and
periodically comparing the operating and consequential profiles of a node/sensor association to determine whether said association is valid.
